(19) United States
(12) Patent Application Publication
(10) Pub. No.: US 2023/0403704 A1
(43) Pub. Date: Dec. 14, 2023

(54) DYNAMIC UPDATE OF LATENCY SENSITIVE TRAFFIC

(71) Applicant: Senscomm Semiconductor Co., Ltd., Suzhou (CN)

(72) Inventors: Sung Jin PARK, Seoul (KR); Yujin NOH, Laguna Hills, CA (US); Seung Ho CHOO, Suzhou (CN); Daehong KIM, Laguna Hills, CA (US)

(21) Appl. No.: 18/331,871

(22) Filed: Jun. 8, 2023

Related U.S. Application Data
(60) Provisional application No. 63/498,224, filed on Apr. 25, 2023.
(60) Provisional application No. 63/367,190, filed on Jun. 28, 2022.
(60) Provisional application No. 63/366,304, filed on Jun. 13, 2022.

(30) Foreign Application Priority Data
Jun. 1, 2023 (CN) 2023106442419

(51) Int. Cl. H04W 72/1268

(52) U.S. Cl. CPC H04W 72/1268; H04W 84/12

(57) ABSTRACT

An electronic device performs a restricted target wake time (TWT) setup with an access point to specify a restricted TWT service period for delivery of latency sensitive traffic and specify first latency sensitive traffic status information in a downlink direction and second latency sensitive traffic status information in an uplink direction. The device receives a frame from the access point during the restricted TWT service period, wherein the frame includes information for updating the first latency sensitive traffic status information in the downlink and updates the first latency sensitive traffic status information in the downlink.

### CROSS REFERENCE TO RELATED APPLICATION

This application claims benefit of U.S. Provisional Application No. 63/366,304 filed on Jun. 13, 2022, U.S. Provisional Application No. 63/367,190 filed on Jun. 28, 2022, and U.S. Provisional Application No. 63/498,224 filed on Apr. 25, 2023, in the United States Patent and Trademark Office, and China Patent Application No. 2023106442419 filed on Jun. 1, 2023, in the China National Intellectual Property Administration, the entire contents of which are hereby incorporated by reference.

### TECHNICAL FIELD

The disclosure relates to wireless communication systems, and more particularly to, for example, but not limited to, wireless communication devices for dynamic update of latency sensitive traffic.

### BACKGROUND

The wireless local area network (WLAN) continues its growth and has become essential technology for providing wireless data services in different environments. In addition to the increased throughput and overall efficiency requirements as emerging and huge potential use cases, high reliability and low latency are being considered. The example of these use cases are Virtual Reality (VR) and Augmented Reality (AR), immersive gaming, remote office, and cloud-computing. Those cases require more challenging time-sensitive technologies.

The description set forth in the background section should not be assumed to be prior art merely because it is set forth in the background section. The background section may describe aspects or embodiments of the present disclosure.

### SUMMARY

Embodiments allow the electronic devices to facilitate wireless communication. More particularly, embodiments allow the WLAN and wireless devices to increase throughput and reduce latency.

One aspect of the present disclosure may provide an electronic device for facilitating wireless communication, comprising processing circuitry configured to cause: performing a restricted target wake time (TWT) setup with an access point to specify a restricted TWT service period for delivery of latency sensitive traffic and specify first latency sensitive traffic status information in a downlink direction and second latency sensitive traffic status information in an uplink direction; receiving a frame from the access point during the restricted TWT service period, wherein the frame includes information for updating the first latency sensitive traffic status information in the downlink; and updating the first latency sensitive traffic status information in the downlink.

The frame further may include an enable field indicating whether a receiver of the frame sends information for updating the second latency sensitive traffic status information in the uplink direction.

The processing circuitry may be further configured to cause: checking the enable field; and when the enable field indicates that a receiver of the frame sends information for updating the second latency sensitive traffic status information in the uplink direction, transmitting, in response to the frame, a physical layer (PHY) protocol data unit (PPDU) including information for updating the second latency sensitive traffic status information in the uplink direction, wherein the PPDU includes no data field.

The PPDU may include a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.

The information for updating the second latency sensitive traffic status information in the uplink direction may be included in the third signal field.

The frame may further include a resource unit which is used for the electronic device to transmit the PPDU and the PPDU may be transmitted through the resource unit.

The PPDU may further include a fourth signal field following the third signal field, and the fourth signal field may include data.

The data in the fourth signal field may be under a TWT agreement established before updating the first latency sensitive traffic status information and the second latency sensitive traffic status information.

The information for updating the second latency sensitive traffic status information in the uplink may include a second bitmap including a plurality of bits, wherein each of the plurality of bits in the second bitmap is associated with a respective one of traffic identifiers and indicates whether an associated traffic identifier is classified as latency sensitive traffic stream.

The third signal field may further include an identifier field indicating a TWT service period related to the second latency sensitive traffic status information.

The first latency sensitive traffic status information in the downlink may include a first bitmap including a plurality of bits, wherein each of the plurality of bits in the first bitmap is associated with a respective one of traffic identifiers and indicates whether an associated traffic identifier is classified as latency sensitive traffic stream.

The frame further includes an identifier field indicating a TWT service period related to the first latency sensitive traffic status information.

One aspect of the present disclosure may provide a method performed by processing circuitry of an electronic device for facilitating wireless communication, comprising: performing a restricted target wake time (TWT) setup with an access point to specify a restricted TWT service period for delivery of latency sensitive traffic and specify first latency sensitive traffic status information in a downlink direction and second latency sensitive traffic status information in an uplink direction; receiving a frame from the access point during the restricted TWT service period, wherein the frame includes information for updating the first latency sensitive traffic status information in the downlink; and updating the first latency sensitive traffic status information in the downlink.

The frame may further include an enable field indicating whether a receiver of the frame sends information for updating the second latency sensitive traffic status information in the uplink direction.

The method may further comprises: checking the enable field; and when the enable field indicates that a receiver of the frame sends information for updating the second latency sensitive traffic status information in the uplink direction, transmitting, in response to the frame, a physical layer (PHY) protocol data unit (PPDU) including information for updating the second latency sensitive traffic status information in the uplink direction, wherein the PPDU includes no data field.

The PPDU may include a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.

One aspect of the present disclosure may provide an electronic device for facilitating wireless communication, comprising processing circuitry configured to cause: performing a restricted target wake time (TWT) setup with a station to specify a restricted TWT service period for delivery of latency sensitive traffic and specify first latency sensitive traffic status information in a downlink direction and second latency sensitive traffic status information in an uplink direction; generating a frame including information for updating the first latency sensitive traffic status information in the downlink; and transmitting the frame to the station during the restricted TWT service period.

The frame further may include an enable field indicating whether a receiver of the frame sends information for updating the second latency sensitive traffic status information in the uplink direction.

The processing circuitry may be further configured to cause: when the enable field indicates that a receiver of the frame sends information for updating the second latency sensitive traffic status information in the uplink direction, receiving, in response to the frame, a physical layer (PHY) protocol data unit (PPDU) including information for updating the second latency sensitive traffic status information in the uplink direction, wherein the PPDU includes no data field.

The PPDU may include a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4 illustrates the EHT MU PPDU format in accordance with an embodiment.

FIG. 5 illustrates the EHT TB PPDU format in accordance with an embodiment.

FIG. 6 is a block diagram of an electronic device for facilitating wireless communication in accordance with an embodiment.

FIG. 7 shows a block diagram of a transmitter in accordance with an embodiment.

FIG. 8 shows a block diagram of a receiver in accordance with an embodiment.

FIG. 9 shows an exemplary TWT element format.

FIG. 10 shows an exemplary Control field format.

FIG. 11 shows an exemplary Individual TWT Parameter Set field format.

FIG. 12 shows an exemplary Request Type field format in the Individual TWT Parameter Set field.

FIG. 13 shows an exemplary Broadcast TWT Parameter Set field format.

FIG. 14 shows an exemplary Trigger frame format.

FIG. 15 shows an exemplary EHT variant Common Info field format.

FIG. 16 shows an exemplary HE variant User Info field format.

FIG. 17 shows an exemplary individual TWT operation.

FIG. 18 shows an exemplary broadcast TWT operation.

FIG. 19 shows an exemplary Trigger Dependent User Info subfield format of the latency sensitive traffic report poll trigger frame.

FIG. 20 shows a first type of the Low Sensitive Traffic PPDU in accordance with an embodiment.

FIG. 21 shows a second type of the Low Sensitive Traffic PPDU in accordance with an embodiment.

FIG. 22 shows an exemplary STA LST status information field in the LST PPDU.

FIG. 23 shows an exemplary restricted TWT operation in accordance with an embodiment.

FIG. 24 shows an exemplary restricted TWT operation in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

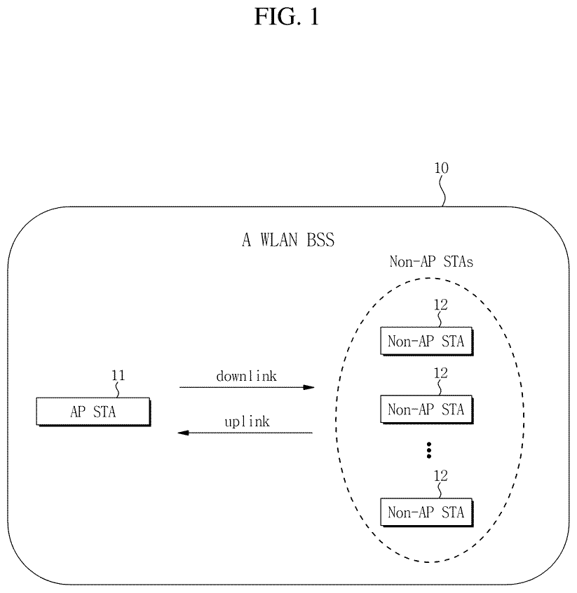

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. The STAs may share a same radio frequency channel with one out of WLAN operation bandwidth options (e.g., 20/40/80/160/320 MHz). Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink frames to the multiple non-AP STAs 12 in the BSS 10 based on different resources and the multiple non-AP STAs 12 may simultaneously transmit the uplink frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

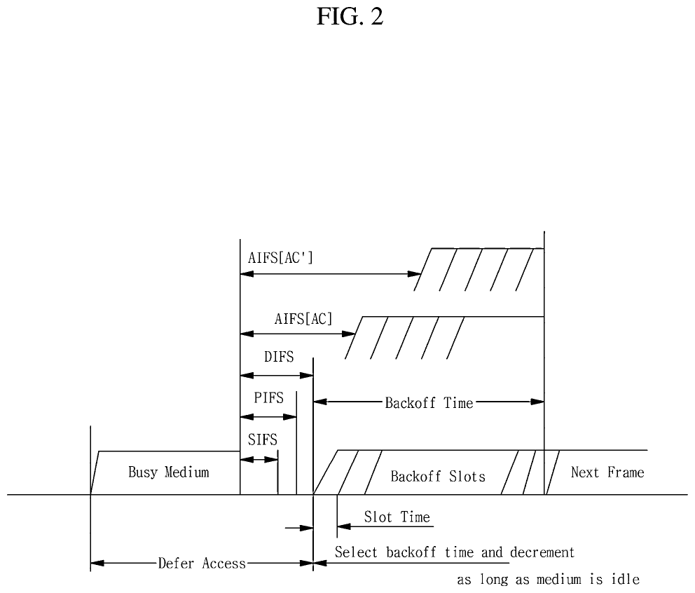

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS [AC] has elapsed. In this case, the data frame, the management frame, or the control frame which is not the response frame may use the AIFC[AC].

In some embodiments, a point coordination function (PCF) enabled AP STA may transmit the frame after performing backoff if a PCF IFS (PIFS) has elapsed. The PIFS duration may be less than the DIFS but greater than the SIFS.

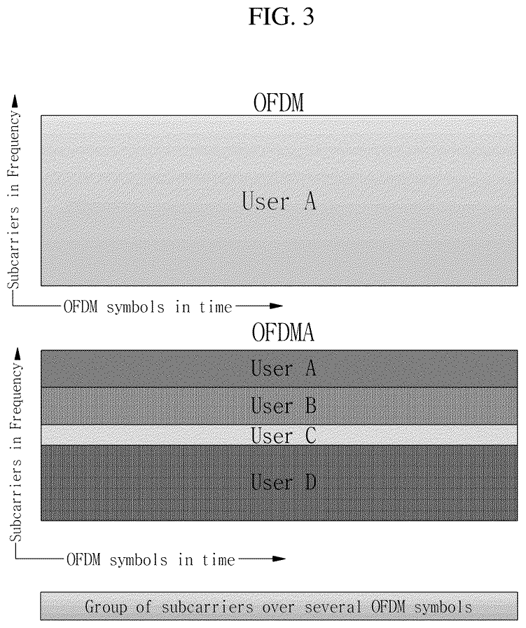

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP STA. The trigger frame may have STA's information and assign RUs and multiple RUs (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

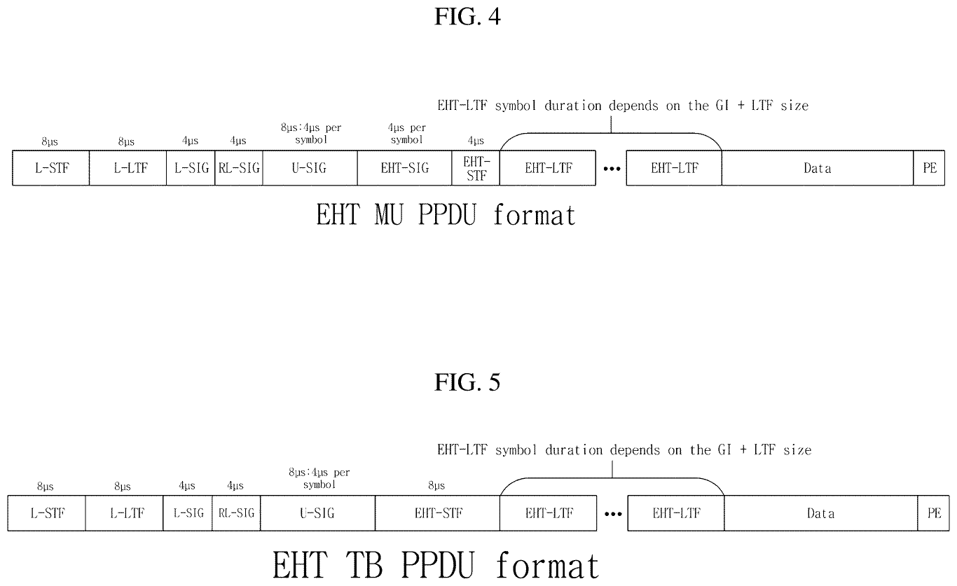

In EHT amendment, two EHT PPDU formats are defined: the EHT MU PPDU and the EHT TB PPDU. Hereinafter, the EHT MU PPDU and the EHT TB PPDU will be described with reference to FIG. 4 and FIG. 5.

FIG. 4 illustrates the EHT MU PPDU format in accordance with an embodiment.

The EHT MU PPDU may be used for transmission to one or more users. The EHT MU PPDU is not a response to a triggering frame.

Referring to FIG. 4, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 5 illustrates the EHT TB PPDU format in accordance with an embodiment.

The EHT TB PPDU may be used for a transmission of a response to a triggering frame.

Referring to FIG. 5, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPDU, the EHT-SIG field is not present because the trigger frame conveys necessary information and the duration of the EHT_STF field in the EHT TB PPDU is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPDU, when the EHT modulated fields occupy more than one 20 MHz channels, the pre-EHT modulated fields may be duplicated over multiple 20 MHz channels.

Hereinafter, electronic devices for facilitating wireless communication in accordance with various embodiments will be described with reference to FIG. 6.

FIG. 6 is a block diagram of an electronic device for facilitating wireless communication in accordance with an embodiment.

Referring to FIG. 6, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 may include one or more physical antennas. When multiple-input multiple-output (MIMO) or multi-user MIMO (MU-MIMO) is used, the antenna unit 34 may include more than one physical antennas.

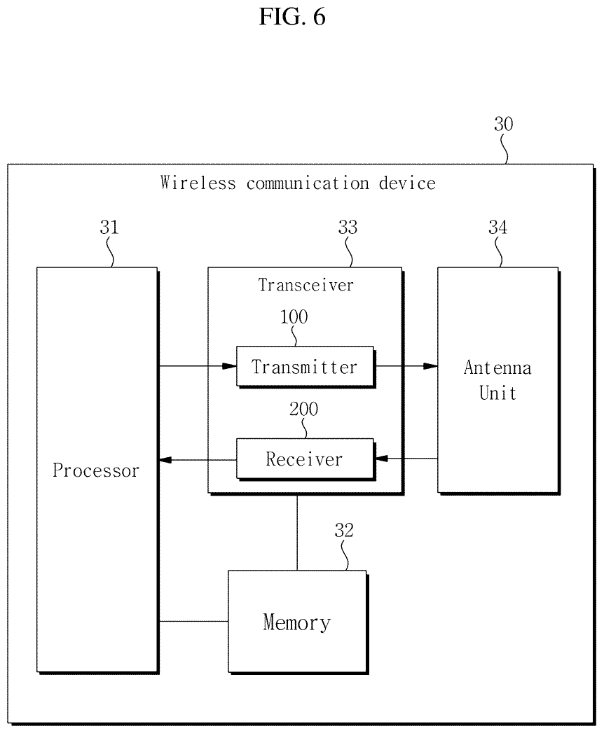

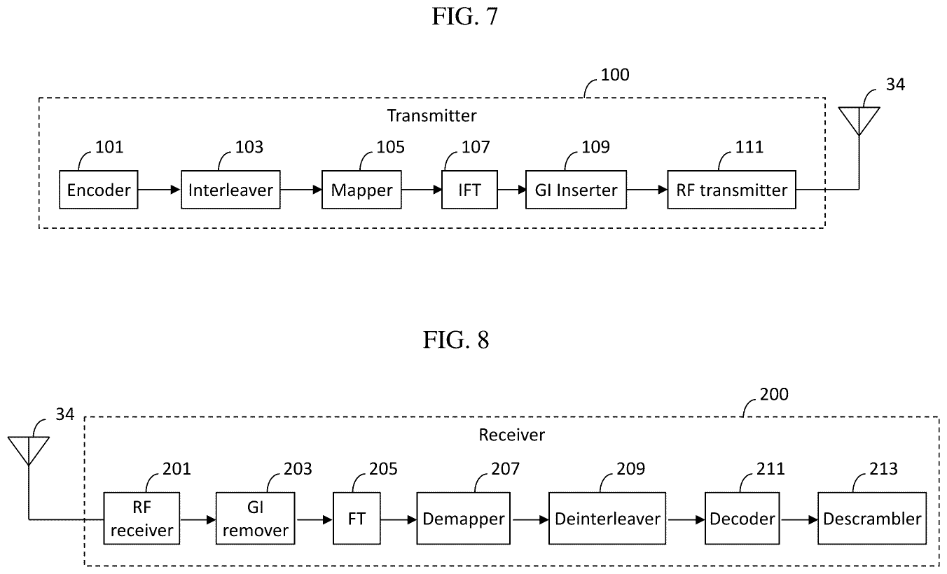

FIG. 7 shows a block diagram of a transmitter in accordance with an embodiment.

Referring to FIG. 7, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

FIG. 8 shows a block diagram of a receiver in accordance with an embodiment.

Referring to FIG. 8, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder.

The descrambler 213 may descramble the descrambled data bits based on a scrambler seed.

Link adaptation (LA) parameters for WLAN systems may be sent as part of the MAC header. The parameters may be carried in an HT control field in the MAC header. Hereinafter, the format of the MAC frame will be described with reference to FIGS. 10A, 10B, 11, 12, and 13.

In order to reduce the latency, the unnecessary overhead traffic or transmission may be removed. For example, WLAN system may support one or more PPDU types with no data field and critical information may be carried in SIG field instead of MAC frame.

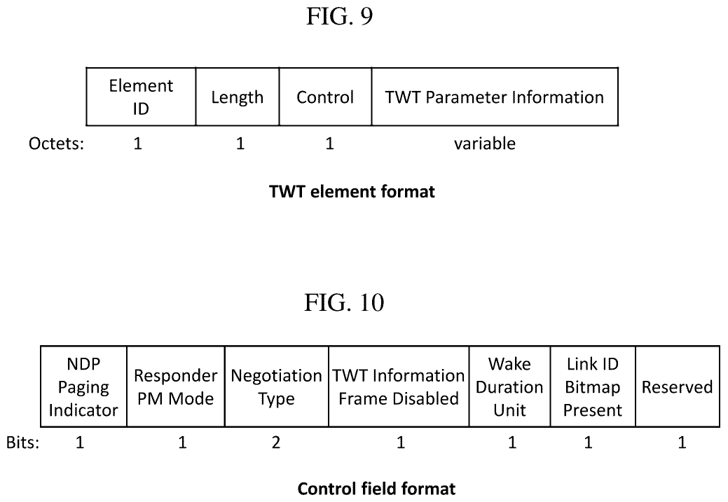

FIG. 9 shows an exemplary TWT element format.

As shown in FIG. 9, the TWT element may include an Element ID field, a Length field, a Control field, and a TWT Parameter Information field.

The Element ID subfield may identify the element. Referring to FIG. 9, the Element ID subfield may indicate that the element containing the element ID is the TWT element.

The Length field may indicate the number of octets in the element excluding the Element ID and Length fields.

The TWT Parameter Information field may contain a single Individual TWT Parameter Set field if a Broadcast subfield in the Control field is 0 and contains one or more Broadcast TWT Parameter Set fields if the Broadcast subfield of the Control field is 1.

The Control field will be described with reference to FIG. 10.

FIG. 10 shows an exemplary Control field format.

As shown in FIG. 10, the Control field in the TWT element may include a NDP Paging Indicator subfield, a Responder PM Mode subfield, a Negotiation Type subfield, a TWT Information Frame Disabled subfield, a Wake Duration Unit subfield, a Link ID Bitmap Present subfield, and a Reserved subfield.

The NDP Paging Indicator subfield may indicate whether a NDP Paging field is present in the TWT element. In some embodiments, the NDP Paging field may be present if the NDP Paging Indicator subfield is equal to 1; otherwise, the NDP Paging field may not be present.

The Responder PM Mode subfield may indicate the power management mode.

The Negotiation Type subfield may indicate whether the information included in the TWT element is for the negotiation of parameters of broadcast or individual TWT(s) or a Wake TBTT interval. The most significant bit (MSB) of the Negotiation Type subfield may be the Broadcast field.

The TWT Information Frame Disabled subfield may indicate whether the reception of TWT Information frames is disabled by the STA. In some embodiments, the TWT Information Frame Disabled subfield may be set to 1 to indicate that the reception of TWT Information frames is disabled by the STA; otherwise, it may be set to 0.

The Wake Duration Unit subfield may indicate the unit of the Nominal Minimum TWT Wake Duration field. In some embodiments, the Wake Duration Unit subfield may be set to 0 if the unit is 256 μs and may be set to 1 if the unit is a time unit (TU) corresponding to a measurement of time equal to 1024 μs.

The Link ID Bitmap Present field may indicate whether the Link ID Bitmap field is present in the Individual TWT Parameter Set field.

The Link ID Bitmap field is present if the Link ID Bitmap Present field is equal to 1; otherwise, the Link ID Bitmap field is not present.

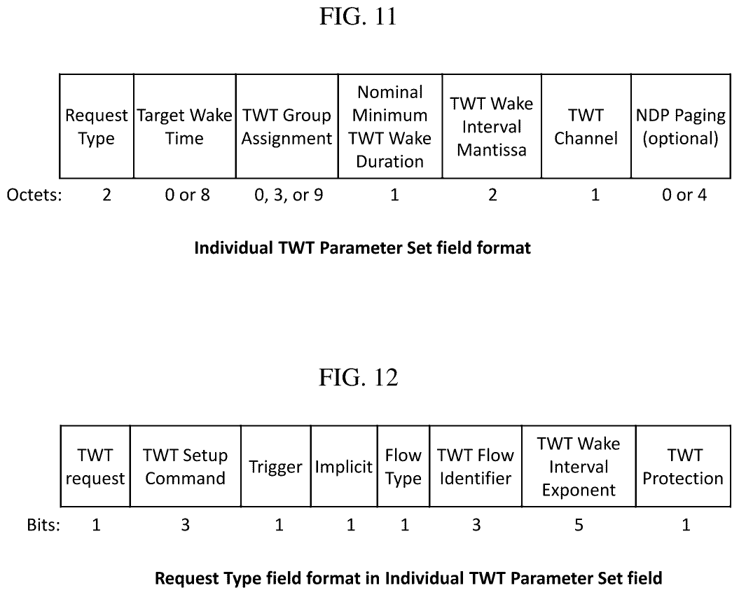

FIG. 11 shows an exemplary Individual TWT Parameter Set field format.

As shown in FIG. 11, an Individual TWT Parameter Set field may include a Request Type subfield, a Target Wake Time subfield, a TWT Group Assignment subfield, a Nominal Minimum TWT Wake Duration subfield, a TWT Wake Interval Mantissa subfield, a TWT Channel subfield, and an NDP Paging subfield.

The Target Wake Time subfield may indicate Target Wake Time corresponding to a next time in microseconds at which the STA participating in the TWT-based communication should wake up for the TWT session. In some embodiments, the Target Wake Time subfield may indicate a future Individual TWT service period (SP) start time, if the Negotiation Type subfield is set equal to 0. The Target Wake Time subfield may indicate a Next Wake TBTT time, if the Negotiation Type subfield is set equal to 1. The Target Wake Time subfield may indicate a future Broadcast TWT SP start time, if the Negotiation Type subfield is set equal to 2. The Target Wake Time subfield may indicate a future Broadcast TWT SP start time, if the Negotiation Type subfield is set equal to 3.

The TWT Group Assignment subfield may provide information to a requesting STA about the TWT group to which the STA is assigned. This field may include a TWT Group ID subfield, a Zero Offset Present subfield, a Zero Offset of Group subfield, a TWT Unit subfield, and a TWT Offset subfield. The TWT Group ID subfield may indicate the identifier of the TWT group to which the requesting STA is assigned. A TWT group may refer to a group of STAs that have TWT values that lie within a specific interval of TSF values. The value zero in the TWT Group ID subfield may be used to indicate the unique TWT group, which contains all STAs in the BSS. The Zero Offset Present subfield may indicate whether the following Zero Offset of Group subfield is included in the TWT Group Assignment field of the TWT element. The Zero Offset of Group subfield may indicate the initial TWT value for the TWT group identified by the TWT group ID. The TWT Unit subfield may indicate the unit of increment of the TWT values within the TWT group identified by the TWT group ID. The TWT Offset subfield may indicate the position within the indicated group, of the STA corresponding to the RA of the frame containing the TWT element.

In some embodiments, the Nominal Minimum TWT Wake Duration subfield may indicate the minimum amount of time, in the unit indicated by the Wake Duration Unit subfield, that the TWT requesting STA or TWT scheduled STA is expected to be awake in order to complete the frame exchanges for the period of TWT wake interval. In some embodiments, the Nominal Minimum TWT Wake Duration subfield may indicate a minimum time duration for which a station shall stay awake since the start time of the TWT session to able to receive frames from the other station. In some embodiments, the Nominal Minimum TWT Wake Duration subfield may be set to higher than 0 when the TWT is periodic.

The TWT Wake Interval Mantissa subfield may indicate TWT wake interval corresponding to the average time that the TWT requesting STA or TWT scheduled STA expects to elapse between successive TWT SPs. The TWT Wake Interval Mantissa subfield may be set to the value of the mantissa of the TWT wake interval value in microseconds, base 2. The TWT wake interval of the requesting STA may be equal to (TWT Wake Interval Mantissa)×2^{(TWT Wake Interval Exponent)}.

The TWT Channel subfield may include a bitmap that provides the channel that is being negotiated by a STA as a temporary channel during a TWT SP. Each bit in the bitmap may correspond to one minimum width channel for the band in which the TWT responding STA's associated BSS is currently operating, with the least significant bit corresponding to the lowest numbered channel of the operating channels of the BSS. In some embodiments, the minimum width channel may be equal to 20 MHz.

The NDP Paging subfield may include a P-ID field, a Max NDP Paging Period field, a Partial TSF Offset field, an Action field, and a Min Sleep Duration field. The P-ID field may refer to the identifier of the paged STA. The Max NDP Paging Period field may indicate the maximum number of TWT wake intervals between two NDP Paging frames. The Partial TSF Offset field may include timing indications. Upon reception of an NDP Paging frame with matching the P-ID field, the TWT STA that is an NDP Paging requester may takes an action indicated by the Action field. The Min Sleep Duration field in the NDP Paging Request may indicate in units of SIFS the minimum duration that STA will be in the doze state after receiving an NDP Paging frame with a matching P-ID.

The Request Type subfield in the Individual TWT Parameter Set field will be described with reference to FIG. 12.

FIG. 12 shows an exemplary Request Type field format in the Individual TWT Parameter Set field.

As shown in FIG. 12, the Request Type field of the Individual TWT Parameter set field may include a TWT request subfield, a TWT Setup Command subfield, a Trigger subfield, an Implicit subfield, a Flow Type subfield, a TWT Flow Identifier subfield, a TWT Wake Interval Exponent subfield, and a TWT Protection subfield.

The TWT Request subfield may indicate whether a STA that transmits a TWT element with the TWT Request subfield is a TWT requesting STA. In some embodiments, a STA that transmits a TWT element with the TWT Request subfield equal to 1 may be a TWT requesting STA or TWT scheduled STA. Otherwise, it may be a TWT responding STA or TWT scheduling STA.

The TWT Setup Command subfield may indicate the type of TWT command. In some embodiments, values 0, 1, 2, 3, 4, 5, 6, and 7 of the TWT Setup Command subfield may indicate that the type of TWT command corresponds to Request TWT, Suggest TWT, Demand TWT, TWT Grouping, Accept TWT, Alternate TWT, Dictate TWT, and Reject TWT, respectively.

The Trigger field may indicate whether or not the TWT SP indicated by the TWT element includes triggering frames. The Trigger field is set to 1 to indicate that at least one triggering frame is transmitted during the TWT SP. The Trigger field is set to 0 otherwise.

The Implicit subfield is set to 1 to indicate an implicit TWT and is set to 0 to indicate an explicit TWT.

The Flow Type subfield may indicate the type of interaction between the TWT requesting STA or TWT scheduled STA and the TWT responding STA or TWT scheduling AP at a TWT. Setting the Flow Type subfield to 0 may indicate an announced TWT in which the TWT requesting STA or TWT scheduled STA will send a PS-Poll or an automatic power save delivery (APSD) trigger frame to signal its awake state to the TWT responding STA or TWT scheduling AP before a frame that is not a Trigger frame is sent from the TWT responding STA or TWT scheduling AP to the TWT requesting STA or TWT scheduled STA. A TWT SP that is set up under an announced TWT agreement may be an announced TWT SP. Setting the Flow Type subfield to 1 may indicate an unannounced TWT in which the TWT responding STA or TWT scheduling AP will send a frame to the TWT requesting STA or TWT scheduled STA at TWT without waiting to receive a PS-Poll or an APSD trigger frame from the TWT requesting STA or TWT scheduled STA. A TWT SP that is set up under an unannounced TWT agreement may be an unannounced TWT SP. The TWT requesting STA may be expected to send the PS-Poll or APSD trigger frame if the TWT is a trigger-enabled TWT.

The TWT Flow Identifier subfield may contain a 3-bit value which that identifies the specific information for this TWT request uniquely from other requests made between the same TWT requesting STA and TWT responding STA pair.

The TWT Wake Interval Exponent subfield may be set to the value of the exponent of the TWT wake interval value in microseconds, base 2.

The TWT Protection subfield may indicate whether TWT protection is requested for the corresponding TWT(s). A TWT requesting STA sets the TWT Protection subfield to 1 to request the TWT responding STA to provide protection of the set of TWT SPs corresponding to the requested TWT flow identifier by i) allocating RAW(s) that restrict access to the medium during the TWT SP(s) for the TWTs that are set up within an S1G BSS and ii) enabling NAV protection during the TWT SP(s) for the TWTs that are set up within an HE BSS. A TWT requesting STA may set the TWT Protection subfield to 0 if TWT protection is not requested for the corresponding TWT(s).

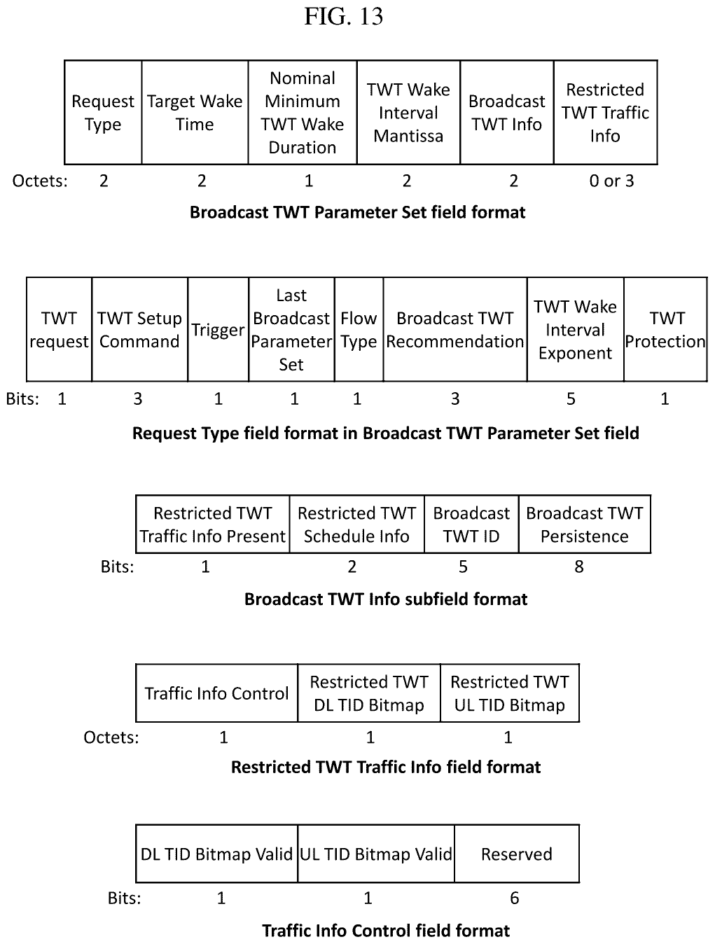

FIG. 13 shows an exemplary Broadcast TWT Parameter Set field format.

As shown in FIG. 13, a Broadcast TWT Parameter Set field may include a Request Type subfield, a Target Wake Time subfield, a Nominal Minimum TWT Wake Duration subfield, a TWT Wake Interval Mantissa subfield, a Broadcast TWT Info subfield, and a Restricted TWT Traffic Info subfield.

The Request Type subfield in the Broadcast TWT Parameter Set field may include a TWT Request subfield, a TWT Setup Command subfield, a Trigger subfield, a Last Broadcast Parameter Set subfield, a Flow Type subfield, a Broadcast TWT Recommendation subfield, TWT Wake Interval Exponent subfield, and a Reserved subfield.

The TWT Request subfield may indicate whether a STA that transmits a TWT element with the TWT Request subfield is a TWT requesting STA. In some embodiments, a STA that transmits a TWT element with the TWT Request subfield equal to 1 may be a TWT requesting STA or TWT scheduled STA. Otherwise, it may be a TWT responding STA or TWT scheduling STA.

The TWT Setup Command subfield may indicate the type of TWT command. In some embodiments, values 0, 1, 2, 3, 4, 5, 6, and 7 of the TWT Setup Command subfield may indicate that the type of TWT command corresponds to Request TWT, Suggest TWT, Demand TWT, TWT Grouping, Accept TWT, Alternate TWT, Dictate TWT, and Reject TWT, respectively.

The Trigger field may indicate whether or not the TWT SP indicated by the TWT element includes triggering frames. The Trigger field is set to 1 to indicate that at least one triggering frame is transmitted during the TWT SP. The Trigger field is set to 0 otherwise.

The Last Broadcast Parameter Set subfield may indicate whether this is the last broadcast TWT Parameter set in the broadcast TWT element. In some embodiments, the Last Broadcast Parameter Set subfield may be set to 0 to indicate that another broadcast TWT Parameter set follows this set. The Last Broadcast Parameter Set subfield may be set to 1 to indicate that this is the last broadcast TWT Parameter set in the broadcast TWT element.

The Flow Type subfield may indicate the type of interaction between the TWT requesting STA or TWT scheduled STA and the TWT responding STA or TWT scheduling AP at a TWT. Setting the Flow Type subfield to 0 may indicate an announced TWT in which the TWT requesting STA or TWT scheduled STA will send a PS-Poll or an automatic power save delivery (APSD) trigger frame to signal its awake state to the TWT responding STA or TWT scheduling AP before a frame that is not a Trigger frame is sent from the TWT responding STA or TWT scheduling AP to the TWT requesting STA or TWT scheduled STA. A TWT SP that is set up under an announced TWT agreement may be an announced TWT SP. Setting the Flow Type subfield to 1 may indicate an unannounced TWT in which the TWT responding STA or TWT scheduling AP will send a frame to the TWT requesting STA or TWT scheduled STA at TWT without waiting to receive a PS-Poll or an APSD trigger frame from the TWT requesting STA or TWT scheduled STA. A TWT SP that is set up under an unannounced TWT agreement may be an unannounced TWT SP. The TWT requesting STA may be expected to send the PS-Poll or APSD trigger frame if the TWT is a trigger-enabled TWT.

The Broadcast TWT Recommendation subfield may contain a value that indicates recommendations on the types of frames that are transmitted by TWT scheduled STAs and scheduling AP during the broadcast TWT SP, encoded according to the Broadcast TWT Recommendation field for a broadcast TWT element. The Broadcast TWT Recommendation may be reserved if transmitted by a TWT scheduled STA. The broadcast TWT parameter set that has the Broadcast TWT Recommendation field value equal to 4 may be referred to as a restricted TWT parameter set. The broadcast TWT element that contains only Restricted TWT Parameter Set field(s) is also referred to as a Restricted TWT element.

The TWT Wake Interval Exponent subfield may be set to the value of the exponent of the TWT wake interval value in microseconds, base 2.

The Target Wake Time subfield may indicate Target Wake Time corresponding to a next time in microseconds at which the STA participating in the TWT-based communication should wake up for the TWT session. In some embodiments, the Target Wake Time subfield may indicate a future Individual TWT SP start time, if the Negotiation Type subfield is set equal to 0. The Target Wake Time subfield may indicate a Next Wake TBTT time, if the Negotiation Type subfield is set equal to 1. The Target Wake Time subfield may indicate a future Broadcast TWT SP start time, if the Negotiation Type subfield is set equal to 2. The Target Wake Time subfield may indicate a future Broadcast TWT SP start time, if the Negotiation Type subfield is set equal to 3.

In some embodiments, the Nominal Minimum TWT Wake Duration subfield may indicate the minimum amount of time, in the unit indicated by the Wake Duration Unit subfield, that the TWT requesting STA or TWT scheduled STA is expected to be awake in order to complete the frame exchanges for the period of TWT wake interval. In some embodiments, the Nominal Minimum TWT Wake Duration subfield may indicate a minimum time duration for which a station shall stay awake since the start time of the TWT session to able to receive frames from the other station. In some embodiments, the Nominal Minimum TWT Wake Duration subfield may be set to higher than 0 when the TWT is periodic.

The TWT Wake Interval Mantissa subfield may indicate TWT wake interval corresponding to the average time that the TWT requesting STA or TWT scheduled STA expects to elapse between successive TWT SPs. The TWT Wake Interval Mantissa subfield may be set to the value of the mantissa of the TWT wake interval value in microseconds, base 2. The TWT wake interval of the requesting STA may be equal to (TWT Wake Interval Mantissa)×2^{(TWT Wake Interval Exponent)}.

The Broadcast TWT Info subfield may include a Restricted TWT Traffic Info Present subfield, a Restricted TWT Schedule Info subfield, a Broadcast TWT ID subfield, and a Broadcast TWT Persistance subfield. The Restricted TWT Traffic Info Present subfield of the Restricted TWT Parameter Set field may be set to 1 if the Restricted TWT Traffic Info field is present; and set to 0 otherwise. The Restricted TWT Traffic Info Present subfield may be reserved for non-EHT STAs. Within a TWT element that includes a TWT setup command value of Request TWT, Suggest TWT, or Demand TWT, the Broadcast TWT ID, if present, may indicate a specific Broadcast TWT in which the transmitting STA is requesting to participate. Within a TWT element that includes a TWT setup command value of Accept TWT, Alternate TWT, Dictate TWT, or Reject TWT, the Broadcast TWT ID, if present, may indicate a specific Broadcast TWT for which the transmitting STA is providing TWT parameters. Within a TWT element that includes a TWT setup command value of TWT Grouping, the Broadcast subfield is 0 and the Broadcast TWT ID, is not present. The value 0 in the Broadcast TWT ID subfield may indicate the broadcast TWT whose membership corresponds to all STAs that are members of the BSS corresponding to the BSSID of the Management frame carrying the TWT element and that is permitted to contain Trigger frames with RA-RUs for unassociated STAs. The Broadcast TWT Persistence subfield may indicate the number of TBTTs during which the Broadcast TWT SPs corresponding to this broadcast TWT Parameter set are present. The number of beacon intervals during which the Broadcast TWT SPs are present may be equal to the value in the Broadcast TWT Persistence subfield plus 1, except that the value 255 indicates that the Broadcast TWT SPs are present until explicitly terminated.

The Restricted TWT Traffic Info field may be present in a Restricted TWT Parameter Set field when the Restricted TWT Traffic Info Present subfield of the Broadcast TWT Info subfield is set to 1. The Restricted TWT Traffic Info subfield may include a Traffic Info Control field, a Restricted TWT DL TID Bitmap field, and a Restricted TWT UL TID Bitmap field. The Traffic Info Control field may include a DL TID Bitmap Valid subfield, and a UL TID Bitmap Valid subfield. The DL TID Bitmap Valid subfield may be set to 1 to indicate that the Restricted TWT DL TID Bitmap field is valid. The DL TID Bitmap Valid subfield may be set to 0 to indicate that the DL traffic of all the TIDs mapped in DL to the link in which the R-TWT membership is being setup, is identified as latency sensitive traffic, and the Restricted TWT DL TID Bitmap field is reserved. The UL TID Bitmap Valid subfield may be set to 1 to indicate that the Restricted TWT UL TID Bitmap field is valid. The UL TID Bitmap Valid subfield may be set to 0 to indicate that the UL traffic of all the traffic identifiers (TIDs) mapped in uplink (UL) to the link in which the R-TWT membership is being setup, is identified as latency sensitive traffic, and the Restricted TWT UL TID Bitmap field is reserved. The Restricted TWT DL TID Bitmap and Restricted TWT UL TID Bitmap subfields may specify the TID(s) that are identified by the R-TWT scheduling AP or the R-TWT scheduled STA as latency sensitive traffic streams in the downlink and uplink direction, respectively. A value of 1 at bit position k in the bitmap may indicate that TID k is classified as latency sensitive traffic stream. A value of 0 at bit position k in the bitmap may indicate that TID k is not classified as latency sensitive traffic stream.

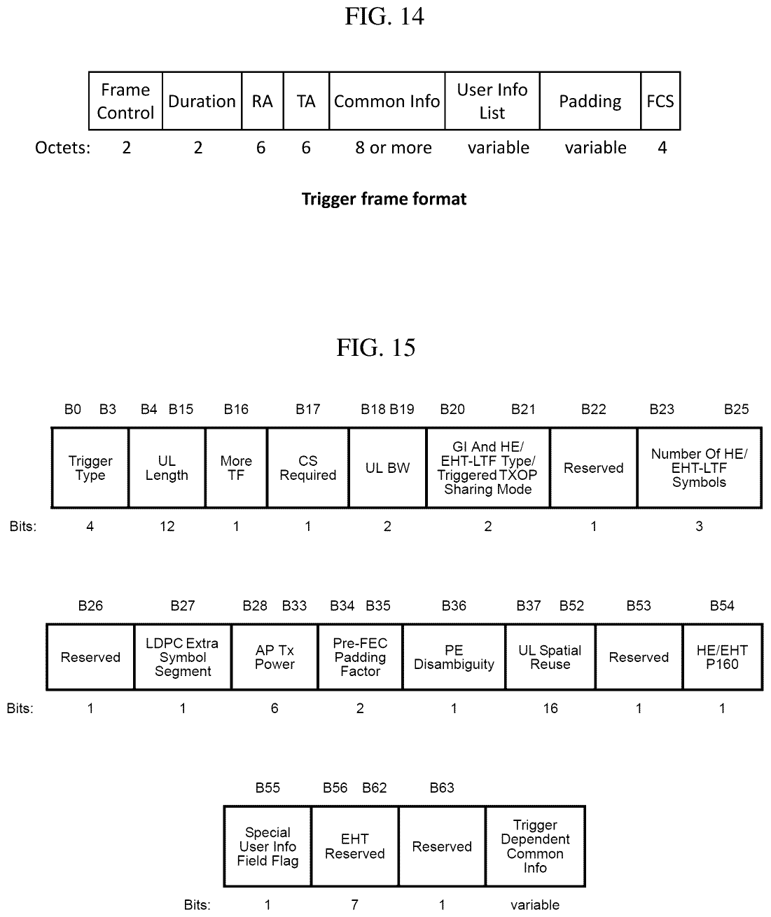

FIG. 14 shows an exemplary Trigger frame format.

As shown in FIG. 14, a trigger frame may include a Frame Control field, a Duration field, a RA field, a TA field, a Common Info field, a User Info List field, a Padding field, and an FCS field.

The Frame Control field may include a type subfield and a subtype subfield. The Type and Subtype subfields together identify the function of the frame. In some embodiments, the type subfield being set to 01 and the subtype subfield being set to 0010 may indicate the frame is the trigger frame.

The RA field may refer to an address of a receiver of the Trigger frame.

The TA field may refer to the address of the STA transmitting the Trigger frame if the Trigger frame is addressed to STAs that belong to a single BSS. The TA field may refer to the transmitted BSSID if the Trigger frame is addressed to STAs from at least two different BSSs of the multiple BSSID set.

The Padding field may be optionally present in a Trigger frame to extend the frame length to give the recipient STAs enough time to prepare a response for transmission a SIFS after the frame is received. The Padding field, if present, may be at least two octets in length and be set to all 1s.

The FCS (frame check sequence) field may contain a 32-bit cyclic redundancy code (CRC). The FCS field value may be calculated over all of the fields of the MAC header and the Frame Body field.

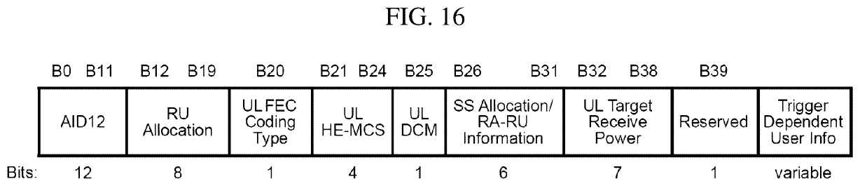

The Common Info field will be described in accordance with FIG. 15. The User Info List subfield will be described in accordance with FIG. 16.

FIG. 15 shows an exemplary EHT variant Common Info field format.

As shown in FIG. 15, the EHT variant Common Info field may include a Trigger Type subfield, a UL Length subfield, a More TF subfield, a CS required subfield, a UL BW subfield, a GI AND HE/EHT-LTF TYPE/Triggered TXOP Sharing Mode subfield, a Reserved subfield, a Number Of HE/EHT-LTF Symbols subfield, a Reserved subfield, a LDPC Extra Symbol Segment subfield, an AP Tx Power subfield, a Pre-FEC Padding Factor subfield, a PE Disambiguity subfield, a UL Spatial Reuse subfield, a Reserved subfield, an HE/EHT P160 subfield, a Special User Info Field Flag subfield, an EHT Reserved subfield, a Reserved subfield, and a Trigger Dependent Common Info subfield.

The Trigger Type subfield identifies the Trigger frame variant and its encoding is defined in Table 1.

TABLE 1

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

The UL Length subfield of the Common Info field may indicate the value of the L-SIG LENGTH field of the solicited TB PPDU.

The More TF subfield of the Common Info field may indicate whether a subsequent Trigger frame is scheduled for transmission.

The CS Required subfield of the Common Info field may be set to 1 to indicate that the STAs identified in the User Info fields are required to use ED to sense the medium and to consider the medium state and the NAV in determining whether to respond. The CS Required subfield may be set to 0 to indicate that the STAs identified in the User Info fields are not required to consider the medium state or the NAV in determining whether to respond.

The UL BW subfield of the HE variant Common Info field may indicate the bandwidth in the HE-SIG-A field of the HE TB PPDU and is defined in Table 2.

TABLE 2

| UL BW subfield value | Description |
|---|---|
| 0 | 20 MHz |
| 1 | 40 MHz |
| 2 | 80 MHz |
| 3 | 80 + 80 MHz or 160 MHz |

The UL BW subfield of the EHT variant Common Info field along with the UL BW Extension subfield of the Special User Info field may indicate the bandwidth in the U-SIG field of the EHT TB PPDU.

The GI And HE/EHT-LTF Type subfield of the Common Info field may indicate the GI and HE/EHT-LTF type of the HE or EHT TB PPDU response. The GI And HE?EHT-LTF Type subfield encoding is defined in Table 3.

TABLE 3

| GI And HE/EHT-LTF Type | |
|---|---|
| subfield value | Description |
| 0 | 1x HE/EHT-LTF + 1.6 μs GI |
| 1 | 2x HE/EHT-LTF + 1.6 μs GI |
| 2 | 4x HE/EHT-LTF + 3.2 μs GI |
| 3 | Reserved |

In an HE variant Common Info field with the Doppler subfield set to 0 or in an EHT variant Common Info field, the Number Of HE-LTF Symbols And Midamble Periodicity subfield of the HE variant Common Info field or the Number Of HE/EHT-LTF Symbols subfield of the EHT variant Common Info field may indicate the number of HE-LTF present in the HE TB PPDU or EHT-LTF symbols present in the HEEHT TB PPDU, respectively.

The LDPC Extra Symbol Segment subfield of the Common Info field may indicate the status of the LDPC extra symbol segment. It may be set to 1 if the LDPC extra symbol segment is present in the solicited HE TB PPDUs and may be set to 0 otherwise.

The AP Tx Power subfield of the Common Info field may indicate the AP's combined transmit power at the transmit antenna connector of all the antennas used to transmit the triggering PPDU in units of dBm/20 MHz. The transmit power in dBm/20 MHz, PTX, may calculated as PTX=−20+FVal, where FVal is the value of the AP Tx Power subfield, except for the values above 60, which are reserved.

The Pre-FEC Padding Factor and PE Disambiguity subfields are defined in Table 4 and have the same encoding as their respective subfields in HE SIG-A or as in their respective subfields in EHT-SIG.

TABLE 4

| Subfield | Description | Encoding |
|---|---|---|
| Pre-FEC | Indicates the pre- | Set to 0 to indicate a pre-FEC padding factor of 4 |
| Padding Factor | FEC padding factor | Set to 1 to indicate a pre-FEC padding factor of 1 |
| | | Set to 2 to indicate a pre-FEC padding factor of 2 |
| | | Set to 3 to indicate a pre-FEC padding factor of 3 |
| PE | Indicates PE | When an HE TB PPDU is solicited, set to 1 if the |
| Disambiguity | disambiguity | condition in Equation 1 is met; otherwise it is set to 0 |
| | | When an EHT TB PPDU is solicited, set to 1 if the |
| | | condition in Equation 1 is met; otherwise it is set to 0 |

$${T}_{PE} + 4 \times ( ⌈ \frac{TX TIME - Signal Extension - 20}{4} ⌉ - ( \frac{TX TIME - Signal Extension - 20}{4} ) ) \geq {T}_{SYM} \qquad Equation 1$$

where
T_{PE} is the PE field duration
T_{SYM} is the symbol duration of the Data field
SignalExtension is 0 μs if TXVECTOR parameter NO_SIG_EXTN is true and is aSignalExtension if TXVECTOR parameter NO_SIG_EXTN is false

The UL Spatial Reuse subfield may include four Spatial Reuse subfields. When the Trigger frame solicits an EHT TB PPDU, each Spatial Reuse n subfield, 1≤n≤4, of the EHT variant Common Info field is determined based on either the EHT Spatial Reuse 1 subfield or the EHT Spatial Reuse 2 subfield of the Special User Info field.

An EHT AP may set HE/EHT P160 subfield of the EHT variant Common Info field to 0 to indicate to an EHT STA that the solicited TB PPDU in the primary 160 MHz is an EHT TB PPDU and may set HE/EHT P160 subfield of the EHT variant Common Info field to 1 to indicate that the solicited TB PPDU in the primary 160 MHz is an HE TB PPDU.

The Special User Info Field Flag subfield may be always set to 0 in an EHT variant Common Info field, indicating that a Special User Info field is included in the Trigger frame that contains the EHT variant Common Info field.

The Trigger Dependent Common Info subfield in the Common Info field may be optionally present based on the value of the Trigger Type field.

FIG. 16 shows an exemplary HE variant User Info field format.

As shown in FIG. 16, the HE variant User Info field may include a AID12 subfield, an RU Allocation subfield, a UL FEC Coding Type subfield, a UL HE-MCS subfield, a UL DCM subfield, a SS Allocation/RA-RU Information subfield, a UL Target Receive Power subfield, a Reserved subfield, a Trigger Dependent User Info subfield.

The AID12 subfield may be encoded as defined in Table 5

TABLE 5

| AID12 subfield | Description |
|---|---|
| 0 | User Info field allocates one or more contiguous |
| | RA-RUs for associated STAs |
| 1-2007 | User Info field is addressed to an associated STA |
| | whose AID is equal to the value in the AID12 |
| | subfield |
| 2008-2044 | Reserved |
| 2045 | User Info field allocates one or more contiguous |
| | RA-RUs for unassociated STAs |
| 2046 | Unallocated RU |
| 2047-4094 | Reserved |
| 4095 | Start of Padding field |

The RU Allocation subfield along with the UL BW subfield in the Common Info field may identify the size and the location of the RU. If the UL BW subfield indicates 20 MHz, 40 MHz, or 80 MHz PPDU, then B0 of the RU Allocation subfield may be set to 0. If the UL BW subfield indicates 80+80 MHz or 160 MHz, then B0 of the RU Allocation subfield may be set to 0 to indicate that the RU allocation applies to the primary 80 MHz channel and set to 1 to indicate that the RU allocation applies to the secondary 80 MHz channel.

The UL FEC Coding Type subfield of the User Info field may indicate the code type of the solicited HE TB PPDU. The UL FEC Coding Type subfield may be set to 0 to indicate BCC and set to 1 to indicate LDPC.

The UL HE-MCS subfield of the User Info field may indicate the HE-MCS of the solicited HE TB PPDU.

The UL DCM subfield of the User Info field may indicate DCM of the solicited HE TB PPDU. The UL DCM subfield may be set to 1 to indicate that DCM is used in the solicited HE TB PPDU. The UL DCM subfield may be set to 0 to indicate that DCM is not used. The UL DCM subfield may be set to 0 if the UL STBC subfield of the Common Info field is set to 1.

If the AID12 subfield is either 0 or 2045, then B26-B31 of the User Info field may be the RA-RU Information subfield; otherwise, B26-B31 of the User Info field may be the SS Allocation subfield.

The SS Allocation subfield of the User Info field may indicate the spatial streams of the solicited HE TB PPDU. The SS Allocation subfield may include a Starting Spatial Stream subfield and a Number Of Spatial Streams subfield. The Starting Spatial Stream subfield may indicate the starting spatial stream and is set to the starting spatial stream minus 1. The Number Of Spatial Streams subfield may indicate the number of spatial streams, and is set to the number of spatial streams minus 1.

The RA-RU Information subfield of the User Info field may indicate the RA-RU information. The RA-RU Information subfield may include a Number Of RA-RU subfield and a More RA-RU subfield. The Number Of RA-RU subfield may indicate the number of contiguous RUs allocated for UORA. The value of the Number Of RA-RU subfield may be equal to the number of contiguous RA-RUs minus 1. The More RA-RU subfield may be set to 1 to indicate that RA-RUs of the type indicated by the AID12 subfield in this User Info field are allocated in subsequent Trigger frames that are sent until the end of the TWT SP in which the Trigger frame carrying this field is sent. Otherwise, the subfield may be set to 0. The More RA-RU subfield may be reserved if the More TF field in the Common Info field is set to 0.

The UL Target Receive Power subfield may indicate the expected receive signal power, measured at the AP's antenna connector and averaged over the antennas, for the HE portion of the HE TB PPDU transmitted on the assigned RU.

The Trigger Dependent User Info subfield in the User Info field is optionally present based on the value of the Trigger Type field.

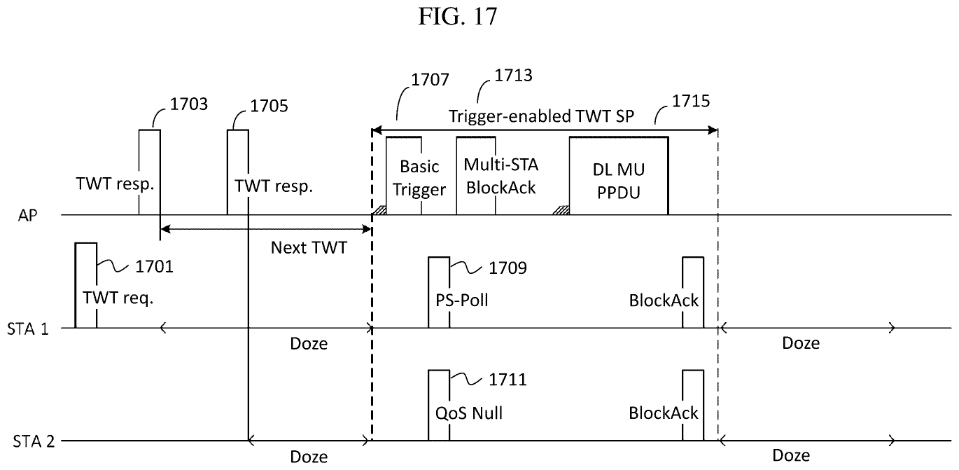

FIG. 17 shows an exemplary individual TWT operation.

As shown in FIG. 17, the STA 1 may send a TWT request 1701 to the TWT responding STA to setup a trigger-enabled TWT agreement. The TWT request may be sent with the TWT Setup frame including the Individual TWT element.

The TWT responding STA may accept the TWT agreement with STA 1 and confirm the acceptance in the TWT response 1703 sent to STA 1. Subsequently, the TWT responding STA may send an unsolicited TWT response 1705 to STA 2 to set up a trigger-enabled TWT agreement with STA 2. Both these TWT agreements may be set up as announced TWTs. The TWT response 1703 and the TWT response 1705 may be sent with the TWT Setup frame including the Individual TWT element.

During the trigger-enabled TWT SP, the TWT responding STA sends a Basic Trigger frame 1707 to which the TWT requesting STAs indicate that they are awake during the TWT SP.

The STA 1 may indicate that it is awake by sending a PS-Poll frame 1709, and STA 2 may indicate that it is awake by sending a QoS Null frame 1711 in response to the Basic Trigger frame 1707.

The AP may send a DL MU PPDU 1715 to plurality of STAs including STA 1 and STA 2 within the SP.

The plurality of STAs including STA 1 and STA 2 may receive their downlink bufferable units in a subsequent exchange with the AP, send BlockAck frames to the AP, and go to doze state outside of this TWT SP.

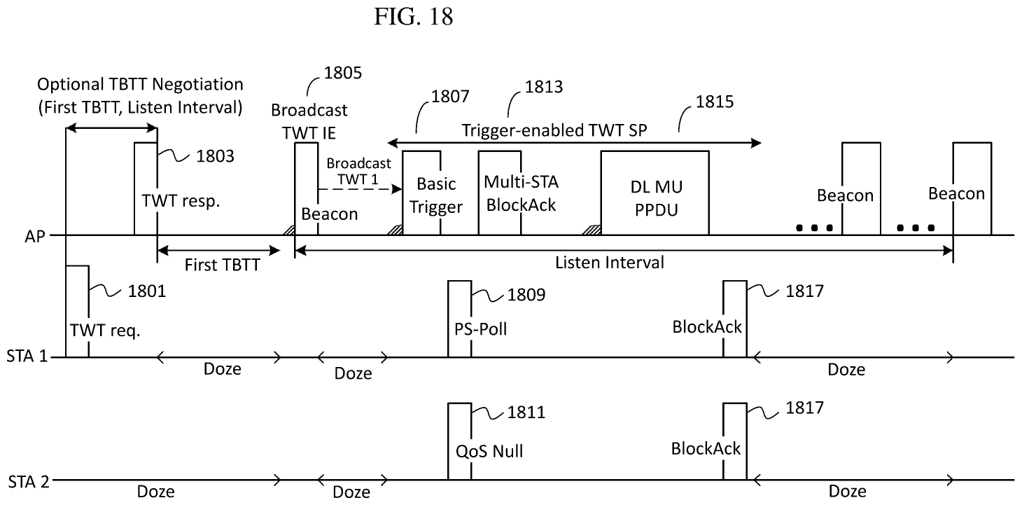

FIG. 18 shows an exemplary broadcast TWT operation.

As shown in FIG. 18, the TWT scheduling AP may perform a target beacon transmission time (TBTT) negotiation procedure with respect to the STA 1.

In some embodiments, for the TBTT negotiation, the STA 1 may transmit a TWT request frame 1801 to the AP. The TWT request 1801 may be sent with the TWT Setup frame including the Broadcast TWT element.

The AP may transmit a TWT response frame 1803, in response to the TWT request frame. The TWT response 1803 may be sent with the TWT Setup frame including the Broadcast TWT element. The TWT response 1803 may include information for allocating a broadcast TWT ID. The TBTT negotiation procedure may be optional.

The AP may transmit a beacon 1805. The TWT scheduling AP may include the broadcast TWT element in the Beacon frame 1805 that indicates a broadcast TWT SP during which the AP intends to send Trigger frames, or DL BUs to the TWT scheduled STAs. STA 1 and STA 2 wake to receive the Beacon frame to determine the broadcast TWT.

The AP may transmit a trigger frame 1807 within the SP to a plurality of STAs. In some embodiments, the AP may transmit the trigger frame, in order to receive data buffered in the plurality of STAs including the STA 1 and the STA 2.

During the trigger-enabled TWT SP, the AP may send a Basic Trigger frame to which STA 1 and STA 2 indicate that they are awake during the TWT SP. STA 1 may indicate that it is awake by sending a PS-Poll 1809, and STA 2 may indicate that it is awake by sending a QoS Null frame 1811 in response to the Basic Trigger frame.

The AP may send a Multi-STA BlockAck frame 1813 to the plurality of STAs including STA 1 and STA 2 in response to the PS-Poll 1809 and the QoS Null frame 1811.

The AP may send a DL MU PPDU 1815 to plurality of STAs including STA 1 and STA 2 within the SP.

The plurality of STAs including STA 1 and STA 2 may receive their downlink bufferable units in a subsequent exchange with the AP and go to doze state outside of this TWT SP.

Hereinafter the Target Wake Time (TWT) operation will be described in more detail.

With the TWT mechanism, non-AP STAs may agree with the AP STA on a common wake scheduling, allowing them to wake up only when required, hence to minimize energy consumption and contention within the Basic Service Set (BSS). The BSS may refer to a wireless network formed by the AP STA and the associated non-AP STAs. The TWT session or Session Period (SP) may refer to the time period in which one or more non-AP STAs are awake to receive or send data. The TWT Agreement may refer to the final arrangement between the AP STA and the non-AP STAs, established agreement after negotiation, to define the details of the TWT SP(s). The non-AP STAs may belong to, for example, but not limited to, the specific time period the non-AP STAs has to wake up. In some embodiments, one TWT agreement may allow the non-AP STAs to participate in multiple TWT SPs which make the non-AP STAs wake up periodically. A TWT agreement may allow DL, UL or both types of transmissions, according to the negotiation and to further instructions that the AP STA can provide at the beginning of each TWT SP through a Trigger frame.

To initiate a TWT session, there is a negotiation phase in which the AP STA and the target station agree on a common set of parameters as shown in FIG. 11, FIG. 12, and FIG. 13, among which the most relevant include a Target Wake Time, a TWT Wake interval, a Minimum TWT wake duration, a TWT Channel, and a TWT Protection. The Target Wake Time (TWT) may refer to a next time in microseconds at which the station participating in the TWT-based communication should wake up for the TWT session. The TWT Wake interval may refer to the time interval between subsequent TWT sessions for the station; the value is higher than 0 when the TWT is periodic. The Minimum TWT wake duration may refer to a minimum time duration a station shall stay awake since the starting time of the TWT session so as to be able to receive frames from the other station(s). The TWT Channel may refer to the channel a station can use temporarily as the primary one, similar to the Subchannel Selective Transmission of IEEE 802.11ah. The TWT Protection may refer to mechanism employed to protect a TWT session from transmissions of external stations, such as the RTS/CTS.

During the negotiation phase, also the following aspects may be defined. First, the TWT agreement may be explicit or implicit. The explicit TWT agreement may require specification of the TWT parameters before each new session and the implicit TWT agreement may allow to set periodic sessions by relying on the first set of parameters until a new set is received. In addition, two different operation modes including a trigger-enabled mode and a non-trigger-enabled mode inside a TWT session may exist. In the trigger-enabled mode, the AP STA may Trigger frames to schedule stations' transmissions. In the non-trigger-enabled, the use of Trigger frames may not be required and it may allow each station to decide when to transmit autonomously inside the TWT session. Finally, when an AP STA sets up a TWT session with a station(s), the TWT session may be specified as Announced or Unannounced. The announced TWT may imply that the station(s) have to send messages to the AP STA to require buffered data. The unannounced TWT may allow the AP STA to deliver data without waiting any previous frame from the station(s), leveraging the fact that all stations from a TWT session must be awake when it starts. Once the TWT parameters are agreed, the stations may go to sleep until the next TWT session is reached. In some embodiments, each station may establish up to 8 TWT agreements with the AP, as each agreement may be identified by a 3-bit value in the TWT Flow Identifier subfield. The requesting station may refer to the one initiating the setup of a TWT session, and the responding station may refer to the one accepting or rejecting the request. To create a new TWT session, the requesting station may send a TWT Request message to the responding station. The TWT Request message may include the parameters for the TWT session, including the minimum TWT wake duration, the TWT wake interval and the TWT channel.

Another pair of request-response messages may be required to conclude the agreement negotiation phase. When the final response has the TWT Setup Command field of Accept TWT, a TWT agreement may be set up. From the time the TWT agreement is set up, the requesting station may go to sleep until the next TWT session starts. The Request type field in the Individual TWT Parameter Set field or the Broadcast TWT Parameter Set field may contain some important subfields. The TWT Setup Command field may specify the type of message (e.g., request, suggest, accept). In addition, the Trigger and Implicit fields in the Individual TWT Parameter Set field may be used to specify the operation mode, and the Flow type field may indicate whether the TWT session is announced or unannounced. The AP STA may have multiple TWT agreements, each one with a different station, but some of them may overlap in time. In this case, the stations may be scheduled by the AP STA for simultaneous transmissions or may have to contend for the medium through random access.

The Broadcast TWT operation may allow an AP STA to set up a shared TWT session for a group of stations and specify periodically the TWT parameters set within Beacon frames. The stations of a Broadcast TWT agreement may be required to wake up to receive only the Beacons containing instructions for the Broadcast TWT sessions they belong to. The AP STA may advertise existing Broadcast TWT agreements so that stations may ask membership to existing TWT sessions or send requests to create new ones.

In order to request the participation in a Broadcast TWT agreement, a station may have to send a TWT Request to the AP STA. Such a request can be sent also in response to a participation request solicited by the AP STA to all the associated stations that support TWT. Similar to the Individual case, in the negotiation phase the station may request, suggest or demand the set of TWT parameters of the Broadcast TWT session, and the AP STA may accept or reject the request, or propose an alternative setting. The TWT parameters may be decided by the AP STA. During the setup phase, the station may also negotiate other two fundamental parameters including a next target beacon transmission time and a listen interval. The next target beacon may refer to the next transmission time of a Beacon including TWT information relevant for the station related to the Broadcast TWT session the station belongs to. The listen interval may refer an interval between subsequent beacons carrying TWT information relevant for the station.

The station may go to doze state and wake up at the time at which the next relevant Beacon is scheduled. These Beacons may carry the necessary information about the Broadcast TWT session that allow the involved stations to follow the session schedule. In addition, the AP STA may also broadcast any update on the TWT parameter set of the session so that all the involved stations can properly update it. As in the Individual agreement, the Broadcast TWT session may be either Trigger-enabled or not, and it may be implemented as Announced or Unannounced, working the same way.

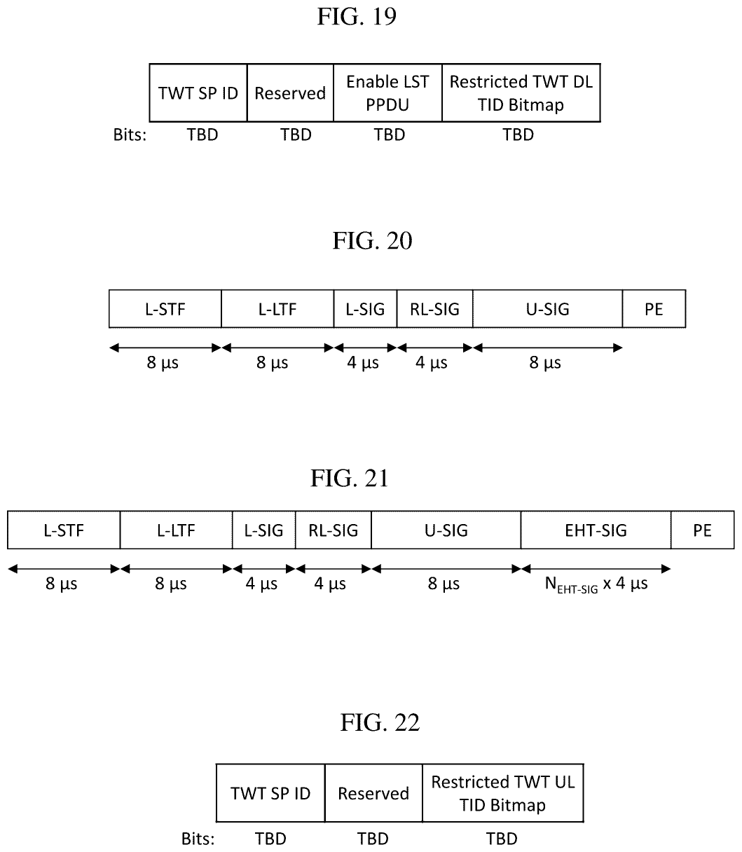

Hereinafter, exemplary restricted TWT operations will be described with reference to FIG. 19 through FIG. 24.

As described above, during the TWT setup, an AP STA and an associated STA may establish a TWT agreement through TWT negotiation. The TWT which has made an agreement by reflecting the status of latency sensitive traffic (LST) to improve low latency is called restricted TWT (R-TWT). The R-TWT operation may enable the STAs in the BSS to use enhanced medium access protection and resource reservation mechanisms for delivery of latency sensitive traffic. The status information for this LST may be applied to a TWT interval until the next TWT agreement. Because it is not possible to update the status of the current LST until the next TWT agreement is made, the change in the LST status cannot be quickly reflected. The exemplary restricted TWT operations may provide a method for dynamically informing the AP STA and the associated non-AP STA of the updated status of LST information by using a latency sensitive traffic report poll (LSTRP) trigger frame and a latency sensitive traffic (LST) PPDU.

FIG. 19 shows an exemplary Trigger Dependent User Info subfield format of the latency sensitive traffic report poll trigger frame.

The latency sensitive traffic report poll (LSTRP) frame may have the trigger frame format shown in the FIG. 14.

Because the type of a trigger frame may be determined as shown in Table 1 through the Trigger Type subfield, the LSTRP frame may be assigned one of the reserved values among 8 to 15. For example, the reserved value of 8 may be assigned to the LSTRP frame.

The Trigger Dependent User Info subfield may be variant depending on the type of the trigger frame. If the type of trigger frame is set to the LSTRP, the Trigger Dependent User Info subfield may be configured for LST update and include a TWT SP ID field, an Enable LST PPDU field, and a Restricted TWT DL TID Bitmap field as shown in FIG. 19.

In some embodiments, the TWT SP ID field may have, not limited to, 5 bits, the Enable LST PPDU field may have, not limited to, 1 bit, and the Restricted TWT DL TID Bitmap field may have, not limited to, 8 bits.

The TWT SP ID field may indicate which TWT SP the updated status of latency sensitive traffic is applied to. In some embodiments, if the TWT SP ID field is set equal to the predetermined value, the updated status of the latency sensitive traffic may be applied regardless of the specific TWT SP duration. The predetermined value may be 0 or 1.

The Enable LST PPDU field may indicate whether STAs receiving the LSTRP trigger frame may transmit the LST PPDU to report status information of their LST. In some embodiments, if Enable LST PPDU field is set to 1, it may indicate that STAs receiving the LSTRP trigger frame may, or are required to, transmit the LST PPDU to report LST status information. If Enable LST PPDU field is set to 0, it may indicate that STAs receiving the LSTRP trigger frame may not, or are not required to, transmit the LST PPDU to report LST status information.

The Restricted TWT DL TID Bitmap field may indicate that Restricted TWT DL TID Bitmap subfield specifies which TID(s) are identified by the TWT scheduling AP STA as latency sensitive traffic streams in the downlink direction. A value of 1 at bit position k in the bitmap may indicate that TID k is classified as latency sensitive traffic stream. A value of 0 at bit position k in the bitmap may indicate that TID k is not classified as latency sensitive traffic stream.

The LSTRP trigger frame may dynamically update the status of latency sensitive traffic of the AP STA and request the most recent status of latency sensitive traffic of STAs.

If the STA receives the LSTRP trigger frame from the AP STA, the STA may report the current LST status of the STA to the AP STA using the LST PPDU. The various LST PPDU formats will be described with reference to FIG. 20 and FIG. 21.

FIG. 20 shows a first type of the Low Sensitive Traffic PPDU in accordance with an embodiment.

Referring to FIG. 20, the LST PPDU may include, or consist of, a L-STF, a L-LTF, a L-SIG field, a RL-SIG field, a U-SIG field and a packet extension (PE) field.

FIG. 21 shows a second type of the Low Sensitive Traffic PPDU in accordance with an embodiment.

Referring to FIG. 21, the LST PPDU may include, or consist of, a L-STF, a L-LTF, a L-SIG field, a RL-SIG field, a U-SIG field, and an EHT-SIG field, and a packet extension (PE) field.

The U-SIG field in the LST PPDU may include two OFDM symbols (U-SIG-1 and U-SIG-2) with 52 bits. 20 bits (B0 to B19) in U-SIG-1 may be positioned as independent fields. The independent fields may be interpreted as intended for next amendment devices as well. The independent fields may contain a PHY Version Identifier field, a Bandwidth field, a UL/DL field, a BSS Color field, and a TXOP field. The PHY Version Identifier may identify the PHY version and differentiate between different PHY clauses. The Bandwidth field may indicate a bandwidth of the TS PPDU among a plurality of bandwidths including, for example, but not limited to, 20 MHz, 40 MHz, 80 MHz, 160 MHz, and 320 MHz. Two types of channelization for 320 MHz channel may be defined: 320 MHz−1 and 320 MHz−2. The 320 MHz−1 may refer to 320 MHz channel with channel center frequency numbered 31, 95, and 159. 320 MHz−2 may refer to 320 MHz channel with channel center frequency numbered 63, 127, and 191. The UL/DL field may indicate whether the PPDU is sent in uplink (UL) or downlink (DL) and set to the TXVECTOR parameter UPLINK_FLAG. The BSS Color field may indicate an identifier of the BSS and set to the TXVECTOR parameter BSS_COLOR. The TXOP field may indicate duration information for protection of this TXOP. 4 bits (B16 to B19) of cyclic redundancy code (CRC) field and 6 bits (B20-B25) of Tail field may be located in U-SIG-2.

The U-SIG field may include an LST PPDU Extension field indicating whether the LST PPDU includes the EHT-SIG field. In some embodiments, the LST PPDU Extension field may be set to 0 to indicate that the LST PPDU does not include the EHT-SIG field and set to 1 to indicate that the LST PPDU includes the EHT-SIG field.

In order to distinguish whether it is one of the LST PPDU formats or one of existing EHT PPDU formats, the PHY Version Identifier field may indicate that the PPDU is the LST PPDU or the PPDU may include a control information indicating whether the PPDU is the LST PPDU. In some embodiments, the control information may have, or consist of, 1 bit. The control information may be included in the U-SIG field. The control information could be located in one of reserved fields. For example, the control information may be B25 corresponding to Validate field. B25 may be set to 0 to indicate whether a EHT STA stops the decoding further after U-SIG since the contents should be differently interpreted so the STA doesn't decode it correctly. In some embodiments, the control information may be indicated with PHY Version Identifier since the PHY Version Identifier field differentiate between different PHY clauses. The control information may set to 0 for EHT and set to a predetermined value other than 0 for TS PPDU. In some embodiments, the LST PPDU may not include independent fields. When the control information in a PPDU indicates that the PPDU corresponds to the LST PPDU, for example, the PPDU may not include the independent fields but fields differently interpreted from fields in the EHT PPDU. The STA which supports the newly designed LST PPDU format may interpret the fields in U-SIG/EHT-SIG differently comparing to the fields in the EHT PPDU.

The STA's LST status information may be included in the PHY preamble of the LST PPDU. For example, the STA's LST status information may be included in the U-SIG field or EHT-SIG field of the LST PPDU. Fields for the status of LST information may be configured using reserved bits in the existing U-SIG.

When the PPDU transmitted by the STA is indicated to the LST PPDU, the U-SIG field in the LST PPDU may include the fields for the LST state reporting shown in FIG. 22. In some embodiments, in case the space in the U-SIG field is not enough, the control information fields may be carried in either of the U-SIG field or the EHT-SIG field. In some embodiments, some of the fields for the LST state reporting may be included in the U-SIG field and the rest of the fields for the LST state reporting may be included in the EHT-SIG field. More fields may be included for the LST state reporting if additional functions are defined.

FIG. 22 shows an exemplary STA LST status information field in the LST PPDU.

As shown in FIG. 22, the STA LST status information field in the LST PPDU may include a TWT SP ID field and a restricted TWT UL TID Bitmap field. The TWT SP ID field and the Restricted TWT UL TID Bitmap field may be to be determined (TBD). In some embodiments, the TWT SP ID field may have, or consist of, 5 bits and the Restricted TWT UL TID Bitmap field may have, or consist of, 8 bits.

The TWT SP ID field may indicate which TWT SP the updated status of latency sensitive traffic is applied to. In some embodiments, if the TWT SP ID field is set equal to the predetermined value, the updated status of the latency sensitive traffic may be applied regardless of the specific TWT SP duration. The predetermined value may be 0 or 1.

The Restricted TWT UL TID Bitmap field may specify which TID(s) are identified by the TWT scheduled STA as latency sensitive traffic streams in the uplink direction. A value of 1 at bit position k in the bitmap may indicate that TID k is classified as latency sensitive traffic stream. A value of 0 at bit position k in the bitmap may indicate that TID k is not classified as latency sensitive traffic stream.

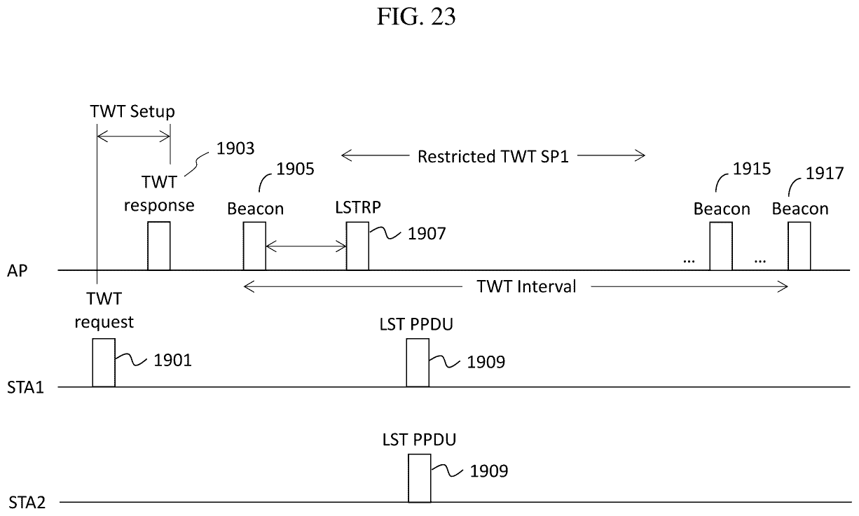

FIG. 23 shows an exemplary restricted TWT operation in accordance with an embodiment.

In general, the restricted TWT operation may follow the Broadcast TWT operation. An R-TWT membership may be established using the same procedure used to set up a broadcast TWT membership as described in FIG. 18 except that the broadcast TWT element(s) carried in the TWT Setup frame include one or more Restricted TWT Parameter Set fields.

For the TBTT negotiation, the STA 1 may transmit a TWT request frame 1901 to the AP. The TWT request 1901 may be sent with the TWT Setup frame including the Restricted TWT element. In some embodiments, the Restricted TWT element may include the Restricted TWT UL TID Bitmap without the Restricted TWT DL TID Bitmap.

The AP may transmit a TWT response frame 1903, in response to the TWT request frame. The TWT response 1903 may be sent with the TWT Setup frame including the Restricted TWT element. In some embodiments, the Restricted TWT element may include the Restricted TWT DL TID Bitmap without the Restricted TWT UL TID Bitmap.

The AP may transmit a beacon 1905. The TWT scheduling AP may include the Restricted TWT element in the Beacon frame 1905 that indicates a Restricted TWT SP. The STA 1 and STA 2 may wake to receive the Beacon frame to determine the Restricted TWT.

In order to update the current status of LST quickly, if the AP STA get the channel, during the Restricted TWT SP, the AP STA may transmit an updated status information on the current LST by using the LSTRP trigger frame 1907 to the membership STAs, for example, including STA 1 and STA 1 that have made a TWT agreement. The STAs that have made the arrangement (TWT agreement) may know the status information of the updated LST of the AP STA.

In some embodiments, the AP STA may request the STAs that have made an agreement through the LSTRP trigger frame to report status information of the LST of the STAs.

In response to the LSTRP trigger frame, the STAs may transmit the LST PPDU 1909 to report status information about their current LST to the AP STA. Then, the AP STA may know the status information of the updated LST of the STAs that have made the agreement. When the trigger frame includes RU allocation subfields which allocate a first resource unit to STA 1 and a second resource unit to STA 2 to request STA 1 and STA 2 to transmit the LST PPDUs, the STA1 may transmit the LST PPDU 1909 through the first resource unit and the STA 2 may transmit the LST PPDU 1909 through the second resource unit.

In some embodiments, the LST under the previous TWT agreement may be transmitted with updating the LST status information. For example, in response to the LSTRP trigger frame, the STAs may transmit the first type of the LST PPDU or the second type of the LST PPDU. In some embodiments, the LSTRP trigger frame may include a field indicating which type of the LST PPDU is sent in response to the LSTRP trigger frame.

The first type of the LST PPDU may include an updated status information of the LST in the U-SIG field.

The second type of the LST PPDU may include an updated status information of the LST in the U-SIG field and data under the previous TWT agreement in the EHT-SIG field.

Through this procedure, the APs and STAs participating in the R-TWT may recognize the status of the changed or updated LST before the next TWT setup with the TWT negotiation and the TWT agreement when the status information for the LST is changed or updated.

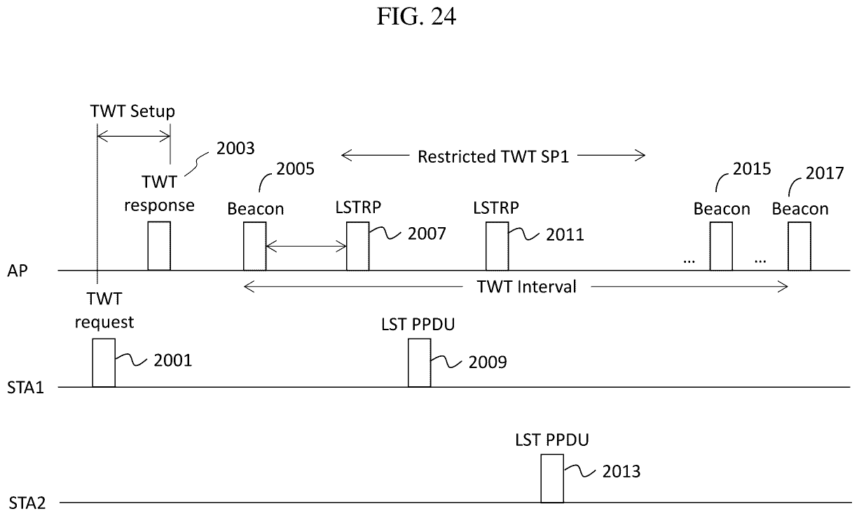

FIG. 24 shows an exemplary restricted TWT operation in accordance with an embodiment.

The restricted TWT operation as shown in FIG. 24 may be the same as the restricted TWT operation as shown in FIG. 23 except that a plurality of LSTRP trigger frame may be used during the Restricted TWT SP.

The Restricted TWT agreement may be established by the TWT request 2001 transmitted from STA 1 to AP and the TWT response 2003 transmitted from AP to STA 1.

The AP may transmit a beacon 2005 including information about a Restricted TWT SP.

The STA 1 may transmit the LST PPDU 2009 in response to the LSTRP trigger frame 2007 and the STA 2 may transmit the LST PPDU 2013 in response to the LSTRP trigger frame 2011.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An electronic device for facilitating wireless communication, comprising processing circuitry configured to cause:
performing a restricted target wake time (TWT) setup with an access point to specify a restricted TWT service period for delivery of latency sensitive traffic and specify first latency sensitive traffic status information in a downlink direction and second latency sensitive traffic status information in an uplink direction;
receiving a frame from the access point during the restricted TWT service period, wherein the frame includes information for updating the first latency sensitive traffic status information in the downlink; and
updating the first latency sensitive traffic status information in the downlink.

2. The electronic device of claim 1, wherein the frame further includes an enable field indicating whether a receiver of the frame sends information for updating the second latency sensitive traffic status information in the uplink direction.

3. The electronic device of claim 2, wherein the processing circuitry is further configured to cause:
checking the enable field; and
when the enable field indicates that a receiver of the frame sends information for updating the second latency sensitive traffic status information in the uplink direction, transmitting, in response to the frame, a physical layer (PHY) protocol data unit (PPDU) including information for updating the second latency sensitive traffic status information in the uplink direction, wherein the PPDU includes no data field.

4. The electronic device of claim 3, wherein the PPDU includes a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.

5. The electronic device of claim 4, wherein the information for updating the second latency sensitive traffic status information in the uplink direction is included in the third signal field.

6. The electronic device of claim 4, wherein the frame further includes a resource unit which is used for the electronic device to transmit the PPDU,
the PPDU is transmitted through the resource unit.

7. The electronic device of claim 4, wherein the PPDU further includes a fourth signal field following the third signal field,
the fourth signal field includes data.

8. The electronic device of claim 4, wherein the data in the fourth signal field is under a TWT agreement established before updating the first latency sensitive traffic status information and the second latency sensitive traffic status information.

9. The electronic device of claim 8, wherein the information for updating the second latency sensitive traffic status information in the uplink includes a second bitmap including a plurality of bits, each of the plurality of bits in the second bitmap is associated with a respective one of traffic identifiers and indicates whether an associated traffic identifier is classified as latency sensitive traffic stream.

10. The electronic device of claim 3, wherein the third signal field further includes an identifier field indicating a TWT service period related to the second latency sensitive traffic status information.

11. The electronic device of claim 1, wherein the first latency sensitive traffic status information in the downlink includes a first bitmap including a plurality of bits, each of the plurality of bits in the first bitmap is associated with a respective one of traffic identifiers and indicates whether an associated traffic identifier is classified as latency sensitive traffic stream.

12. The electronic device of claim 1, wherein the frame further includes an identifier field indicating a TWT service period related to the first latency sensitive traffic status information.

13. A method performed by processing circuitry of an electronic device for facilitating wireless communication, comprising:
performing a restricted target wake time (TWT) setup with an access point to specify a restricted TWT service period for delivery of latency sensitive traffic and specify first latency sensitive traffic status information in a downlink direction and second latency sensitive traffic status information in an uplink direction;
receiving a frame from the access point during the restricted TWT service period, wherein the frame includes information for updating the first latency sensitive traffic status information in the downlink; and
updating the first latency sensitive traffic status information in the downlink.

14. The method of claim 13, wherein the frame further includes an enable field indicating whether a receiver of the frame sends information for updating the second latency sensitive traffic status information in the uplink direction.

15. The method of claim 14, further comprising:
checking the enable field; and
when the enable field indicates that a receiver of the frame sends information for updating the second latency sensitive traffic status information in the uplink direction, transmitting, in response to the frame, a physical layer (PHY) protocol data unit (PPDU) including information for updating the second latency sensitive traffic status information in the uplink direction, wherein the PPDU includes no data field.

16. The method of claim 15, wherein the PPDU includes a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.

17. An electronic device for facilitating wireless communication, comprising processing circuitry configured to cause:
performing a restricted target wake time (TWT) setup with a station to specify a restricted TWT service period for delivery of latency sensitive traffic and specify first latency sensitive traffic status information in a downlink direction and second latency sensitive traffic status information in an uplink direction;
generating a frame including information for updating the first latency sensitive traffic status information in the downlink; and
transmitting the frame to the station during the restricted TWT service period.

18. The electronic device of claim 17, wherein the frame further includes an enable field indicating whether a receiver of the frame sends information for updating the second latency sensitive traffic status information in the uplink direction.

19. The electronic device of claim 18, wherein the processing circuitry is further configured to cause:
when the enable field indicates that a receiver of the frame sends information for updating the second latency sensitive traffic status information in the uplink direction, receiving, in response to the frame, a physical layer (PHY) protocol data unit (PPDU) including information for updating the second latency sensitive traffic status information in the uplink direction, wherein the PPDU includes no data field.

20. The electronic device of claim 19, wherein the PPDU includes a PHY preamble including a first short training field (STF) corresponding to a non-high-throughput (Non-HT) short training field (L-STF), a first long training field (LTF) corresponding to a Non-HT long training field (L-LTF), a first signal field corresponding to a Non-HT signal (L-SIG) field, a second signal field corresponding to a repeated Non-HT signal (RL-SIG) field, and a third signal field corresponding to a universal signal (U-SIG) field.
